(19) United States
(12) Patent Application Publication
(10) Pub. No.: US 2021/0179028 A1
(43) Pub. Date: Jun. 17, 2021

(54) WINDSCREEN WIPER DEVICE

(71) Applicant: FEDERAL-MOGUL S.A., AUBANGE (BE)

(72) Inventor: XAVIER BOLAND, ARLON (BE)

(21) Appl. No.: 16/077,199

(22) PCT Filed: Feb. 15, 2016
(86) PCT No.: PCT/EP2016/053149

§ 371 Date: Aug. 10, 2018

(51) Int. Cl. B60S 1/40; B60S 1/38

(52) U.S. Cl. CPC B60S 1/4087; B60S 1/3849

(57) ABSTRACT

A windscreen wiper device of the flat blade type includes an elastic, elongated carrier element, as well as an elongated wiper blade of a flexible material, which can be placed in abutment with a windscreen to be wiped, which wiper blade includes at least one groove, in which groove a longitudinal strip of the carrier element is disposed, which windscreen wiper device comprises a connecting device for an oscillating arm, wherein the oscillating arm can be pivotally connected to the connecting device about a pivot axis near one end thereof, the connecting device comprising at least two parts provided with protrusion/hole means for detachably connecting the parts together, wherein the first part is retained onto the wiper blade and wherein the second part comprises a channel for receiving a rod-like extension of the oscillating arm, wherein the windscreen wiper device is provided with first and second retention means for retaining the connecting device onto the oscillating arm, wherein the first retention means are formed by protrusion/hole means on the rod-like extension of the oscillating arm and on an inner wall of the channel for snappingly interconnecting the rod-like extension of the oscillating arm and the second part of the connecting device.

### BACKGROUND

### 1. Technical Field

The present invention relates to a windscreen wiper device of the flat blade type comprising an elastic, elongated carrier element, as well as an elongated wiper blade of a flexible material, which can be placed in abutment with a windscreen to be wiped, which wiper blade includes at least one groove, in which groove a longitudinal strip of the carrier element is disposed, which windscreen wiper device comprises a connecting device for an oscillating arm, wherein the oscillating arm can be pivotally connected to the connecting device about a pivot axis near one end thereof. The longitudinal strip is also called a “flexor”, while the connecting device is also indicated as a “connector”.

Preferably, the wiper blade comprises a spoiler at a side thereof facing away from the windscreen to be wiped. The spoiler is also called an “air deflector” and is preferably made in one piece with the wiper blade. The wiper blade and the spoiler are preferably made through extrusion.

In use, the oscillating arm is connected to a mounting head mounted on a drive shaft, wherein the oscillating arm at one end thereof is pivotally connected to the mounting head by means of a pivot pin and at another end thereof is connected to the wiper blade placed in abutment with the windscreen to be wiped. In use, the shaft rotates alternately in a clockwise and in a counter-clockwise sense carrying the mounting head into rotation also, which in turn draws the oscillating arm into rotation and by means of the connecting device moves the wiper blade. The oscillating arm can thus oscillate to-and-from between a first and second reversal positions.

It is noted that the present invention is not restricted to automobiles, but also refers to rail coaches and other (fast) vehicles.

Further, it is noted that the present invention is not restricted to the use of only one longitudinal strip forming the elastic carrier element that is particularly located in a central longitudinal groove of the wiper blade. Instead, the carrier element may also comprise two longitudinal strips, wherein the strips are disposed in opposite longitudinal grooves of the wiper blade, the groove(s) may be closed at one outer end.

The present invention also relates to a connecting device arranged for use in such a windscreen wiper device.

### 2. Related Art

Such a windscreen wiper device is generally known. This prior art windscreen wiper device is designed as a “flat blade” or “yokeless blade”, wherein no use is made of several yokes pivotally connected to each other, but wherein the wiper blade is biased by the carrier element, as a result of which it exhibits a specific curvature.

In practice it has become apparent that, during use of the known windscreen wiper device, high forces are exerted on the connection between the connecting device and the oscillating arm. As a consequence thereof the wiper blade may get loose from the oscillating arm.

The object of the invention is to provide a windscreen wiper device, wherein the connecting device and the oscillating arm are connected in an improved manner, using a minimum of parts.

Thereto, a windscreen wiper device of the type referred to in the introduction is characterized according to the invention in that the connecting device comprising at least two parts provided with protrusion/hole means for detachably connecting the parts together, wherein the first part is retained onto the wiper blade and wherein the second part comprises a channel for receiving a rod-like extension of the oscillating arm, wherein the windscreen wiper device is provided with first and second retention means for retaining the connecting device onto the oscillating arm, wherein the first retention means are formed by protrusion/recess means on the rod-like extension of the oscillating arm and on the channel for snappingly interconnecting the rod-like extension of the oscillating arm and the second part of the connecting device, and wherein a force for deactivating the first retention means is smaller than a force deactivating the second retention means. Particularly, the channel has a closed circumference. More in particular, the channel is formed by a blind hole having a closed circumference. Even more in particular, the rod-like extension and the channel have a rectangular cross-section. Preferably, in accordance with the invention the first retentions means and the second retentions means are each retaining the wiper blade onto the oscillating arm through a connection using protrusion/hole means on the connecting device and the oscillating arm, wherein a force for deactivating (that is releasing) the snapping connection of the first retention means is smaller than a force deactivating a connection of the second retention means. The force for releasing the snapping connection of the first retention means is preferably lying between 10 and 30 N. Particularly, the first retention means are arranged to be active in a wiping position and in a service position of the oscillating arm, while the second retention means are arranged to be only active in the wiping position (and not in the service position) of the oscillating arm. Consequently, in the service position the wiper blade can be easily mounted to or dismounted from the oscillating arm (for replacement or repair thereof, for example), as only a small force for activating or deactivating (i.e., releasing) the snapping connection of the first retention means is needed. In the wiping position of the oscillating arm the second retention means serve retain the wiper blade onto the oscillating arm, also in case the first retention means would disfunction or fail.

Preferably, the rod-like extension of the oscillating arm comprises at least one hole cooperating with a protrusion of the channel. The rod-like extension of the oscillating arm particularly comprises at least two opposing holes cooperating with at least two opposing protrusions of the channel, the two opposing holes are preferably arranged on two respective opposing side walls of the rod-like extension of the oscillating arm, wherein the two opposing protrusions are arranged on two respective lateral sides of the channel, the second part preferably comprises a lever provided with the protrusion, wherein the lever is hingeable between an inward position, wherein the oscillating arm is retained on the second part and an outward position, wherein the oscillating arm is released from the second part. More in particular, the lever is hingeable along hinges of the second part located on opposite sides of the oscillating arm in mounted position thereof, i.e., on opposite sides of the channel arranged for inserting the oscillating arm therein. The second part and the lever are preferably made of one piece. When the first and the second part are snapped together, the lever is preferably not visible from the outside. Particularly, the lever is hingeable between the inward position and the outward position by moving the connecting device relative to the oscillating arm in longitudinal direction of the arm (by hand). Preferably, the first part comprises engaging members made integral therewith for engaging around the longitudinal sides of the longitudinal strips that face away from each other (in case of two flexors) or around the longitudinal sides of the wiper blade that face away from each other (in case of one central flexor). In other words, the engaging members each form a groove for introducing the longitudinal sides therein, so that the first part of the connecting device is firmly retained onto the wiper blade. In order to enhance the retention thereof the engaging members may be welded, soldered, brazed or glued to the longitudinal strips.

In one preferred embodiment of a windscreen wiper device in accordance with the invention the rod-like extension of the oscillating arm comprises at least one protrusion cooperating with a hole of the channel. In particular, the rod-like extension of the oscillating arm comprises at least two opposing protrusions cooperating with at least two opposing holes of the channel, the two opposing protrusions are preferably arranged on two respective opposing side walls of the rod-like extension of the oscillating arm, wherein the two opposing holes are arranged on two respective lateral sides of the channel.

In another preferred embodiment of a windscreen wiper device according to the invention the second retention means are formed by at least one protrusion provided on the first part arranged to engage into a correspondingly shaped hole in the rod-like extension of the oscillating arm.

In another preferred embodiment of a windscreen wiper device in accordance with the invention the hole having an open circumference is provided on a longitudinal side the rod-like extension of the oscillating arm. Preferably, the protrusion extends upwardly from the first part, the protrusion is preferably arranged to engage into the hole in a wiping position of the oscillating arm, wherein the protrusion is arranged to disengage from the hole in a service position of the oscillating arm. In other words, the second retention means are active in the wiping position of the oscillating arm and inactive in the service position of the oscillating arm. The first retention means are always active, i.e. in both the wiping and service positions. Hence, in the service position the wiper blade can be easily mounted on or dismounted from the oscillating arm, as only a minor force is needed for the first retention means.

In another preferred embodiment of a windscreen wiper device according to the invention the first part is positioned at least substantially within the second part. Preferably, the second part has an at least substantially U-shaped cross-section at the location of its connection to the first part, wherein the first part comprises two cylindrical protuberances extending outwards on either side thereof and snappingly engaging into identically shaped cylindrical holes in the legs of the U-shaped cross-section of the second part.

In another preferred embodiment of a windscreen wiper device in accordance with the invention the second part is positioned at least substantially within the first part. Preferably, the second part has an at least substantially U-shaped cross-section at the location of its connection to the first part, wherein the second part comprises two cylindrical protuberances extending outwards on either leg of the U-shaped cross-section thereof and snappingly engaging into identically shaped cylindrical holes in opposite sides of the first part. Each leg of the U-shaped cross-section of the second part is allowed to bend outwardly upon insertion of the rod-like extension of the oscillating arm into the channel thereof for connecting the first and second parts together through a snapping operation.

[symbol]

[symbol]

[symbol]

[symbol]

### THE DRAWINGS

The invention will now be explained in more detail with reference to figures illustrated in a drawing, wherein

FIG. 1A is a schematic and perspective view of a windscreen wiper device and (a part of) an oscillating arm according to the invention;

FIG. 1B is a schematic and perspective view of a part of the windscreen wiper device of FIG. 1, wherein a first part and a second part of a connecting device of the windscreen wiper device is shown connected to the oscillating arm;

FIGS. 2A through 2C are side views of the first part and the second part of the connecting device shown in FIG. 1B, explaining in steps how to retain and to release a unit consisting of a wiper blade and the connecting device on and from the oscillating arm, respectively;

FIGS. 3A and 3B are a top view and a perspective view of the oscillating arm, respectively; and

FIG. 4 is a side view of the first part and the second part of the connecting device shown in FIG. 1B, but pivoted relative to one another.

### DETAILED DESCRIPTION

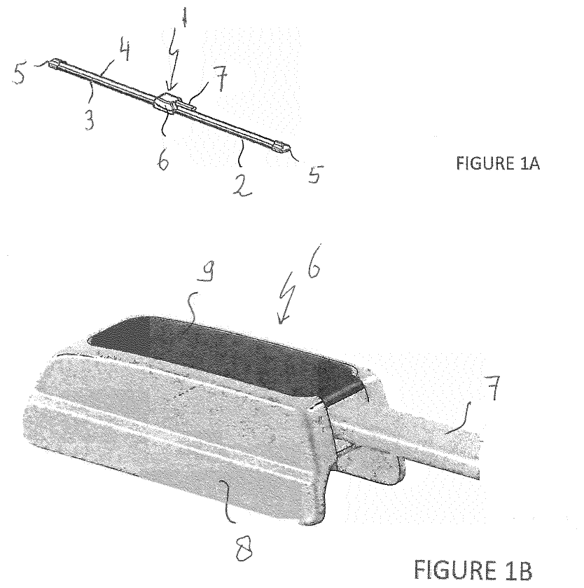

FIG. 1A shows a windscreen wiper device 1 of the “flat blade” type according to the invention, the windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. The strips 4 form a flexible carrier element for the rubber wiper blade 2, as it were, which is thus biased in a curved position (the curvature in operative position being that of a windscreen to be wiped). Neighbouring ends of strips 4 are interconnected on either side of the windscreen wiper device 1 by means of connecting pieces 5 functioning as clamping members. In this embodiment, the connecting pieces may be separate constructional elements, which may be form-locked (“positive locking” or “having positive fit”), as well as force-locked to the ends of strips 4. In another preferred variant, the connecting pieces are in one piece with the strips 4 made of spring band steel. In the latter case the connecting pieces form transverse bridges for the strips 4, as it were. Possibly, a spoiler is furthermore provided.

The windscreen wiper device 1 is furthermore built up of a connecting device 6 of plastic material for an oscillating wiper arm 7. The wiper arm 7 is finalized by an extension (without an adapter). Connecting device 6 consists of a first part 8 and a second part 9 detachably connected together. The first part 8 is retained onto the wiper blade 2, whereas the second part 9 is positioned within the first part 8, that is between parallel, upright walls thereof. Further, the first part 8 comprises clamping members 10 that are integral therewith, which engage round longitudinal sides of the strips 4 that face away from each other, as a result of which the connecting device 6 is firmly attached to the unit consisting of wiper blade 2 and strips 4. The second part 9 has a U-shaped cross-section at the location of its connection to the first part 8. The oscillating wiper arm 7 is pivotally connected to the connecting device 6 about a pivot axis near a free end thereof, and that in the following manner.

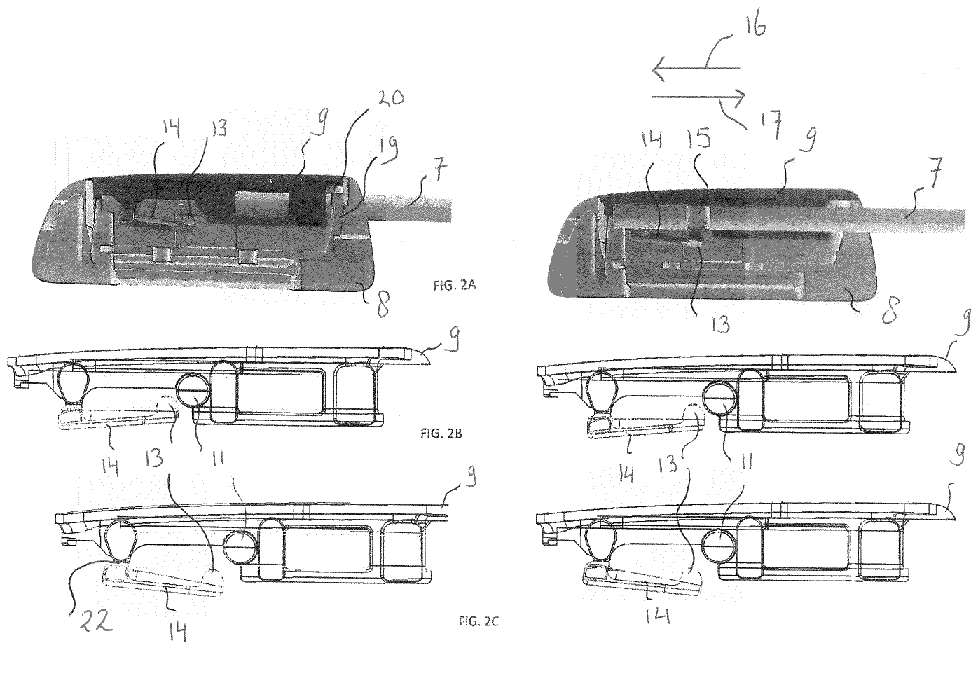

With reference to FIGS. 1 and 2, the second part 9 comprises two cylindrical protrusions 11 (only one is visible) extending outwards on either side of the second part 9, that is on each vertical side wall of its U-shaped, rectangular or square cross-section. These protrusions 11 pivotally engage in identically shaped cylindrical holes 12 (only one thereof is visible in FIGS. 1 and 2) of the first part 8. The protrusions 11 act as bearing surfaces at the location of a pivot axis in order to pivot the second part 9 (and the oscillating wiper arm 7 attached thereto) about the pivot axis near a free end of the arm 7. The protrusions 11 are preferably in one piece with the second part 9. In the alternative, the protrusions 11 are part of a single pivot pin perpendicular to the connecting device 6.

Referring to FIGS. 2A through 2C, the second part 9 comprises a protrusion 1 extending upwardly from a free end of a lever 14 inside the second part 9, while the oscillating arm 7 has an identically shaped hole 15 with a closed circumference at the location of its connection to the second part 9, the lever 14 with the protrusion 13 is hingeable relative to the second part 9 between an inward position (see FIGS. 2A and 2B). Wherein in a mounted position the protrusion 13 engages into the hole 15 provided in the oscillating arm 7 in order to retain the connecting device 6 onto the oscillating arm 7, and an outward position (FIG. 2C), wherein in a dismounted position the protrusion 13 disengages from the hole 15 provided in the oscillating arm 7, allowing the connecting device 6 to be released from the oscillating arm 3. The lever 14 is hingeable along two lateral hinges (22) located near opposite side walls of the second part 9, upon sliding a unit consisting of the wiper blade 2 and the connecting device 6 relative to the oscillating arm 7 by hand in the direction of arrow 16, i.e. in longitudinal direction of the arm 7. More in particular, by applying a force by hand in the direction of arrow 16, the protrusion 13 of the lever 14 will disengage the hole 15 of the oscillating arm 7. The above unit consisting of the wiper blade 2 and the connecting device 6 may then be released from the oscillating arm 7 by hand. In the same position the above unit consisting of the wiper blade 2 and the connecting device 6 may then be mounted on the oscillating arm 7 by hand. Namely, by moving the connecting device 6 relative to the oscillating arm 7 by hand in the direction of arrow 17, due to its resiliency, the lever 14 will hinge from its outward position (FIG. 2C) into its inward position (FIGS. 2A and 2B). The protrusion 13 will then engage the hole 15 of the oscillating arm. The unit is then safely retained onto the oscillating arm 7.

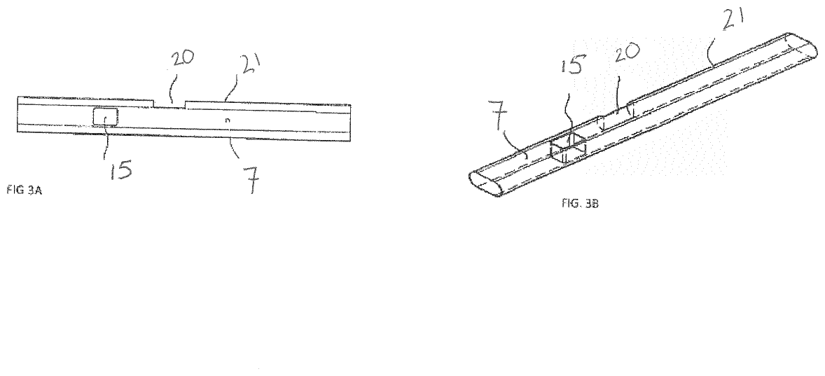

The protrusion 13 on the second part 9 and the hole 15 in the oscillating arm 7 are meant for retaining the connecting device 6 onto the oscillating arm 7 and are therefore called “first retaining means”. However, in case the first retaining means would disfunction, for example when the protrusion 13 would not properly fit into the hole 15, the second part 9 and the first part 8 connected thereto would be able to move relative to the oscillating arm 7 in longitudinal direction of the wiper blade 2. In order to avoid the wiper blade 2 from coming loose, with all negative consequences involved, second retaining means are provided for, the second retaining means consist of an upwardly extending protrusion 19 on at least one of the parallel, upright walls of the first part 8 cooperating with a recess 20 in the oscillating arm 7 (FIGS. 2A and 3). In other words, the protrusion 19 engages into the correspondingly shaped recess 20 provided on a longitudinal (exterior) side 21 of the oscillating arm 7. The protrusion 19 may also be called a cam.

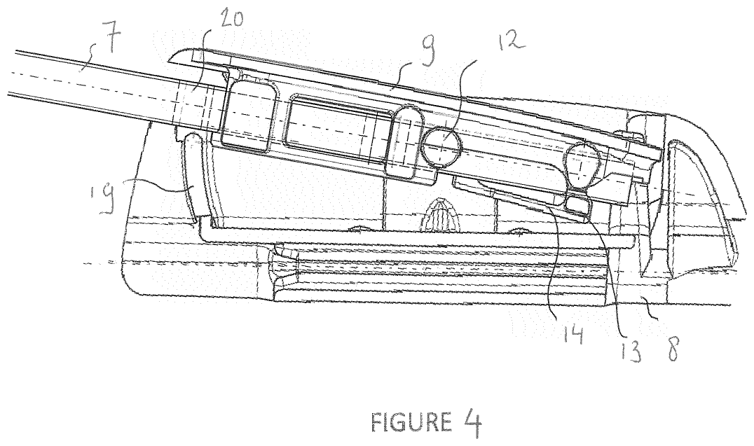

For mounting or dismounting the connecting device 6 onto or from the oscillating arm 7, the second part 9 and thus the free end of the oscillating arm 7 connected thereto is pivoted relative to the first part 8. While carrying out the pivot movement the protrusion or cam 19 is no longer in line with the recess 20 and cannot mutually cooperate any longer, so that the second part 9 and the first part 8 attached thereto can be released from the oscillating arm 7. This can, of course, only be done when also the protrusion 13 in all embodiments is released from the hole 15. This is shown in FIG. 4.

In accordance with the invention the first retentions means and the second retentions means are each retaining the wiper blade 2 onto the oscillating arm 7 through a connection using protrusion/recess means on the connecting device and the oscillating arm, wherein a force for deactivating (that is releasing) the snapping connection of the first retention means is smaller than a force deactivating the connection of the second retention means. The three for releasing the snapping connection of the first retention means is preferably lying between 10 and 30 N. Particularly, the first retention means are arranged to be active in a wiping position and in a service position of the oscillating arm, while the second retention means are arranged to be only active in the wiping position (and not in the service position) of the oscillating arm. Consequently, in the service position the wiper blade can be easily mounted to or dismounted from the oscillating arm (for replacement or repair thereof, for example), as only a small force for activating or deactivating (i.e., releasing) the snapping connection of the first retention means is needed. In the wiping position of the oscillating arm the second retention means serve retain the wiper blade onto the oscillating arm, also in case the first retention means would disfunction or fail.

The invention is not restricted to the variants shown in the drawing, but it also extends to other embodiments that fall within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes at least one groove, in which groove a longitudinal strip of the carrier element is disposed, which windscreen wiper device comprises a connecting device for an oscillating arm, wherein said oscillating arm can be pivotally connected to said connecting device about a pivot axis near one end thereof, wherein said connecting device comprising at least two parts provided with protrusion/hole features for detachably connecting said parts together, wherein the first part is retained onto the wiper blade and wherein the second part comprises a channel for receiving a rod-like extension of said oscillating arm, wherein said windscreen wiper device is provided with first and second retention features for retaining said connecting device onto said oscillating arm, wherein the first retention features are formed by associated protrusion/hole features on said rod-like extension of the oscillating arm and on an inner wall of said channel for snappingly interconnecting said rod-like extension of the oscillating arm and the second part of the connecting device, and wherein a force for deactivating the first retention means features is smaller than a force deactivating the second retention features.

2. A windscreen wiper device according to claim 1, wherein said first retention features are arranged to be active in a wiping position and in a service position of the oscillating arm, while said second retention features are arranged to be only active in the wiping position of the oscillating arm.

3. A windscreen wiper device according to claim 1, wherein said rod-like extension of the oscillating arm comprises at least one hole cooperating with a protrusion of said channel.

4. A windscreen wiper device according to claim 3, wherein said rod-like extension of the oscillating arm comprises at least two opposing holes cooperating with at least two opposing protrusions of said channel.

5. A windscreen wiper device according to claim 4, wherein said two opposing holes are arranged on two respective opposing side walls of said rod-like extension of the oscillating arm, and wherein said two opposing protrusions are arranged on two respective lateral sides of said channel.

6. A windscreen wiper device according to claim 1, wherein said rod-like extension of the oscillating arm comprises at least one protrusion cooperating with a hole of said channel.

7. A windscreen wiper device according to claim 6, wherein said rod-like extension of the oscillating arm comprises at least two opposing protrusions cooperating with at least two opposing holes of said channel.

8. A windscreen wiper device according to claim 7, wherein said two opposing protrusions are arranged on two respective opposing side walls of said rod-like extension of the oscillating arm, and wherein said two opposing holes are arranged on two respective lateral sides of said channel.

9. A windscreen wiper device according to claim 1, wherein said protrusion of said channel is provided on a lever.

10. A windscreen wiper device according to claim 1, wherein the second retention means are formed by at least one protrusion provided on the first part arranged to engage into a correspondingly shaped hole in said rod-like extension of the oscillating arm.

11. A windscreen wiper device according to claim 10, wherein said hole having an open circumference is provided on a longitudinal side of said rod-like extension of the oscillating arm.

12. A windscreen wiper device according to claim 10, wherein said protrusion extends upwardly from said first part.

13. A windscreen wiper device according to claim 10, wherein said protrusion is arranged to engage into said hole in a wiping position of said oscillating arm, and wherein said protrusion is arranged to disengage from said hole in a service position of said oscillating arm.

14. A windscreen wiper device according to claim 1, wherein said first part is positioned at least substantially within said second part.

15. A windscreen wiper device according to claim 14, wherein said second part has an at least substantially U-shaped cross-section at the location of its connection to said first part, wherein said first part comprises two cylindrical protuberances extending outwards on either side thereof and snappingly engaging into identically shaped cylindrical holes in said legs of said U-shaped cross-section of said second part.

16. A windscreen wiper device according to claim 1, wherein said second part is positioned at least substantially within said first part.

17. A windscreen wiper device according to claim 16, wherein said first part has an at least substantially U-shaped cross-section at the location of its connection to said second part, wherein said second part comprises two cylindrical protuberances extending outwards on either leg of the U-shaped cross-section thereof and snappingly engaging into identically shaped cylindrical holes in opposite sides of said first part.
